(19) United States
(12) Patent Application Publication
(10) Pub. No.: US 2012/0058309 A1
(43) Pub. Date: Mar. 8, 2012

(54) Sealing Tape of Flexible Foam

(75) Inventor: Martin Deiss, Abtsgmuend (DE)

(73) Assignee: ISO-CHEMIE GMBH, Aalen (DE)

(21) Appl. No.: 13/227,076

(22) Filed: Sep. 7, 2011

(30) Foreign Application Priority Data
Sep. 8, 2010 (EP) 10175847.2

(51) Int. Cl. B32B 3/00

(52) U.S. Cl. 428/158

(57) ABSTRACT

The sealing tape includes a foam strip of flexible foam having a plurality of three-dimensional foam segments, which are separated from each other by cuts extending downward from the top surface into the foam strip. At least some of the plurality of foam segments are surrounded completely in the longitudinal direction and in a direction transverse to the longitudinal direction by other ones of the plurality of foam segments.

### CROSS REFERENCE TO RELATED APPLICATION

This application claims priority based on European patent application EP 10 175 847.2, filed Sep. 8, 2010.

### FIELD OF THE INVENTION

The invention relates to a sealing tape of flexible foam for sealing a joint, e.g., a joint between a structural component such as the frame of a window or door and the wall of a building.

### BACKGROUND OF THE INVENTION

Sealing tapes of this type can be adhered to the structural component to be sealed, and after the component has been mounted in an opening in the building wall, the previously compressed foam strip expands, i.e., returns elastically to its original shape, and thus seals the component off against the building wall. A disadvantage of these known sealing tapes, however, is that the sealing function leaves something to be desired when the masonry is uneven. This is especially true when there are areas of significant unevenness in the masonry of the joint to be sealed.

### SUMMARY OF THE INVENTION

It is an object of the present invention to provide a sealing tape which is simple in design but which offers a superior insulating effect even when the masonry of the joint to be sealed is highly uneven.

According to an aspect of the invention, the sealing tape comprises a foam strip of flexible foam having two side surfaces, a top surface, and a bottom surface, the side surfaces extending along a longitudinal direction. The foam strip comprises a plurality of three-dimensional foam segments, which are separated from each other by cuts extending from the top surface into the foam strip. At least some of the plurality of foam segments are surrounded completely in the longitudinal direction and in a direction transverse to the longitudinal direction by other ones of the plurality of foam segments.

As a result of the segmented design of the foam strip with closely adjacent foam segments, each of which can expand independently of the others, it is possible to compensate for even a significant lack of evenness in the masonry. As a result of the cuts, which are usually extremely narrow, the individual foam segments are separated from each other but rest closely against each other, so that the maximum sealing effect is preserved. In addition, it is relatively simple to produce a sealing tape of this type.

To ensure that large uneven areas in the masonry can be bridged, the foam segments extend over at least 50% of the height of the foam strip, preferably over at least 60% of the height of the foam strip, more preferably over at least 70% of the height of the foam strip, and even more preferably over at least 90% of the height of the foam strip, when the foam strip is in the expanded state.

In such a case, it can be advantageous for the foam strip to comprise a web in the area of its bottom surface, which connects the foam segments to each other providing that they remain a structural whole.

It is also conceivable that, when the foam strip is in the expanded state, the foam segments extend over 100% of the height of the strip. This guarantees maximum independence of the recovery movements of the individual foam segments.

In another preferred embodiment, a plurality of the cuts extends substantially parallel to the side surfaces.

In addition, a plurality of the cuts can extend substantially perpendicular to the side surfaces, so that, when seen from above, a checkerboard type of pattern of foam segments is obtained. Rhombus-shaped designs when seen from above or any other desired geometric design of the foam segments may also contemplated.

In a preferred embodiment, the sealing tape comprises a support layer, which may be adhered to the bottom surface of the foam strip. This support layer serves to connect the individual foam segments to each other.

The support layer is preferably stretchable, as a result of which it is possible for the foam segments to be pulled apart in the transverse direction of the sealing tape, so that joints of different depths can be sealed. The cuts between the individual foam segments can be pulled apart to form intermediate spaces, so that the air enclosed within them can also provide an insulating effect.

It is especially easy to attach the sealing tape to the structural component to be sealed if the support layer is adhesive on both sides or is designed as double-sided pressure-sensitive adhesive tape. Of course, other ways of attaching the sealing tape to the component are also possible, including by means of pressure-sensitive adhesive strips not integrated into the support layer or by means of paste-like, liquid, or hot-melt adhesives, by mechanical linking means or the like.

The sealing tape can be stored and transported in a space-saving and convenient manner, when it is wound up into a roll.

### BRIEF DESCRIPTION OF THE DRAWINGS

Additional features and advantages of the present invention can be derived from the following description, which refers to the drawings:

FIG. 1 is a perspective schematic diagram of a first embodiment of the sealing tape according to the invention;

FIG. 2 is a schematic cross-sectional view of the sealing tape of FIG. 1 in the installed state within a joint to be sealed;

FIG. 3 is a perspective schematic diagram of a second embodiment of the sealing tape according to the invention;

FIG. 4 is a schematic cross-sectional view of the sealing tape of FIG. 3 in the installed state within a joint to be sealed; and

FIG. 5 is a schematic cross-sectional view of the sealing tape of FIG. 3 in an alternative installed state within a deeper joint to be sealed.

### DETAILED DESCRIPTION OF THE INVENTION

In the drawings, the foam strips, adhesive layers, support layers, and cover sheets are shown a certain distance apart in some cases so that the elements which form the sealing tape can be distinguished more clearly from each other. In reality, these elements rest closely against each other. The gap between the sealing tape and the structural component to be sealed does not exist in reality either.

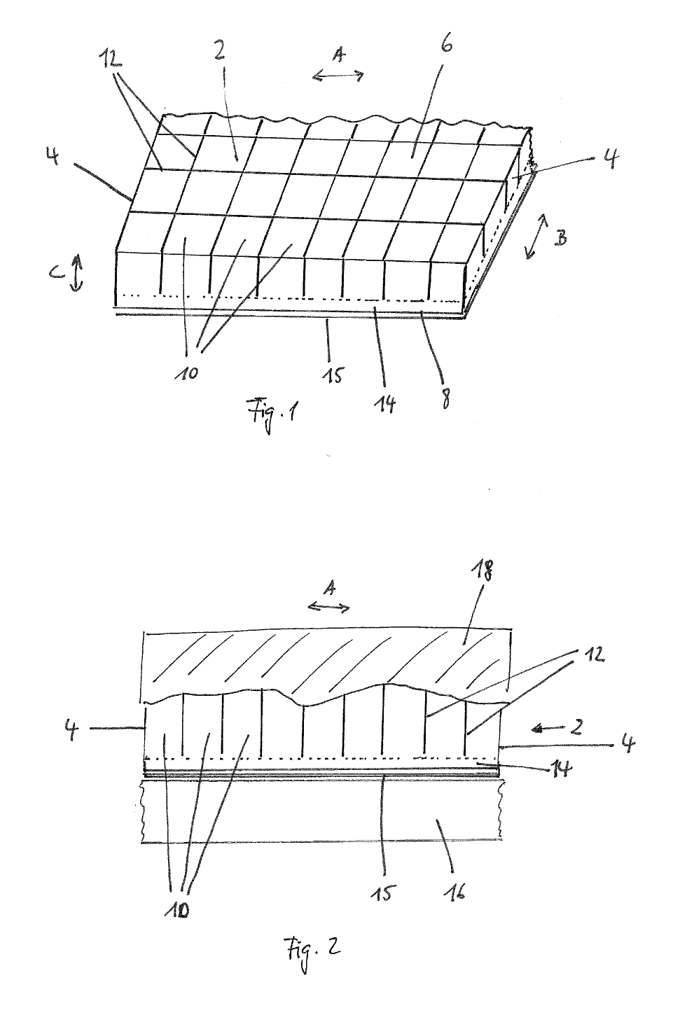

FIG. 1 shows a sealing tape comprising a foam strip 2. In the exemplary embodiment shown, the foam strip has a rectangular cross section, but any other desired shape is also conceivable. Foam strip 2 always has two side surfaces 4, a top surface, 6 and a bottom surface 8.

Foam strip 2 can be made out of any desired open-cell or closed-cell flexible foam such as a polyurethane or polyethylene foam, and it can be impregnated to delay its recovery after release from compression. The weight per unit volume of these flexible foams is in the range of 20-200 kg/m³.

Foam strip 2 usually extends farther in its longitudinal direction (arrow B) than in its transverse direction (arrow A), which simultaneously represents the functional direction of the sealing tape and extends between two side surfaces 4. In practice, foam strip 2 is usually precompressed in such a way that, when the pressure on it is released, it can expand preferably to a thickness approximately 5-10 times greater than that which it had in the precompressed state, although, to assure reliable contact against the building wall facing the profile element to be sealed, only about half of this capacity for expansion is actually used in many cases. Arrow C indicates the direction in which compression and expansion occur.

Foam strip 2 comprises several foam segments 10, which, in the present case, are arranged in rows and columns. These foam segments 10 are obtained by making cuts 12; that is, they are separated from each other by the cuts 12.

All of the cuts 12 extend into foam strip 2 from the top surface 6. In the expanded state of the foam strip, cuts 12 and thus the foam segments 10 extend over at least 50% of the height of the foam strip, preferably up to at least 90% of the height of the foam strip. In the area of the bottom surface 8 of foam strip 2, a web 14 may remain, which connects foam segments 10 to each other. In FIG. 1, this web 14 is shown separated from foam segments 10 by a dotted line, but in reality it forms an integral part of the segments.

In the present example, one set of cuts 12 runs substantially parallel to side surfaces 4 of foam strip 2, and the other set of cuts 12 runs essentially perpendicular to side surfaces 4 of foam strip 2, as a result of which, when seen from above, a checkerboard-like pattern of foam segments 10 is produced. In this way a majority of foam segments 10, that is, all of foam segments 10 except those at the edge of the sealing tape, are completely surrounded by other foam segments 10 in the longitudinal direction B and in the transverse direction A of the sealing tape.

In addition to the illustrated form and direction of cuts 12, many other possible arrangements are conceivable. For example, the cuts can extend in zigzag fashion through the sealing tape or in a wave-like manner or in any other desired, preferably regular, pattern. Accordingly, the shape of the individual foam segments 10 can also be different from the rectangular block shape shown in FIG. 1. Cuts 12 can also extend downward from the top at an angle. Almost any three-dimensional design for the foam segments 10 is conceivable.

The cuts are usually extremely narrow, and they are produced by displacement cutting, i.e., a form of cutting which does not result in the loss of any material when cuts 12 are made in foam strip 2. It is also possible to produce cuts 12 by punching foam material out of foam strip 2, if this is deemed advantageous for certain applications. As a rule, however, it is preferable to make cuts 12 as narrow as possible and to lose as little material as possible when making cuts 12, so that the sealing action of the sealing tape remains as strong as possible.

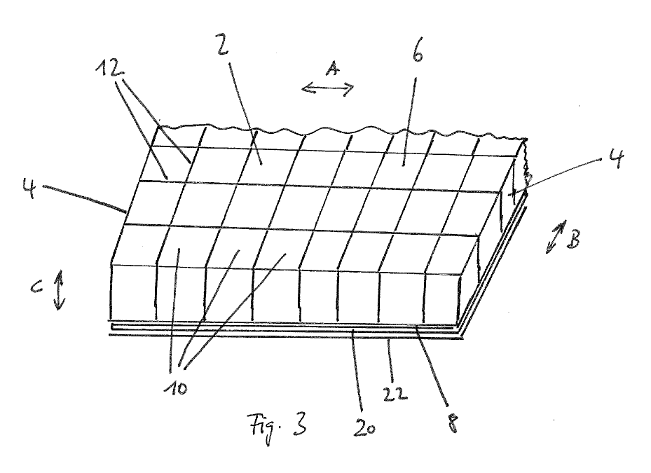

To adhere the sealing tape to a structural component 16 to be sealed such as a frame profile of a window or door (FIG. 2), an adhesive layer 15 is provided on bottom surface 8 of foam strip 2. This adhesive layer 15 is usually covered by a cover sheet (not shown), which is pulled off before the sealing tape is used.

In some cases a mesh fabric, a reinforcing sheet, a nonwoven, etc., can be embedded in this adhesive layer 15 to increase its tensile strength. The term “adhesive layer” is therefore intended to include these types of adhesive layers also.

Adhesive layer 15 is preferably designed as double-sided adhesive tape, which produces a firmly adhering bond between foam strip 2 and the structural component 16. Adhesive layer 15 can also be implemented as a layer of standard commercial adhesive, which is to be applied manually at the construction site.

FIG. 2 shows the installed state of the sealing tape of FIG. 1. It can be seen how even major irregularities in the masonry 18 can be compensated by the sealing tape as a result of the ability of individual foam segments 10 to expand independently of each other, thus ensuring that foam segments 10 make good contact with masonry 18 and produce a reliable and consistent seal.

The embodiment of the sealing tape shown in FIG. 3 is substantially the same as that of FIG. 1 except that it also has a support layer 20 on bottom surface 8 of foam strip 2. In addition, cuts 12 pass down the entire height of foam strip 2, and thus the individual foam segments 10 are held together only by support layer 20. Support layer 20 is adhered to foam strip 2, i.e., to individual foam segments 10, by a gluing or laminating process. Support layer 20 may also be used with the foam segments of smaller height and the linking web mentioned with respect to FIG. 1. Support layer 20 preferably consists of a foamed plastic such as polyethylene, polypropylene, cellular rubber or the like. The material of support layer 20 can also be cloth, nonwoven material, plastic sheeting (of polyethylene, for example, or of polypropylene, polyvinyl chloride, or rubber), mesh, fiber web, or adhesive tape. Strips of plastic, wood, metal, or some other material suitable for the purpose indicated are also contemplate. Combinations of the materials cited above are also possible. The thickness of support layer 20 is in the range between 5 μm and 10 mm, and preferably in the range between 20 μm and 3 mm.

In an especially preferred embodiment, support layer 20 is stretchable. In addition, it is especially advantageous for support layer 20 to be designed as double-sided adhesive tape. In this case, support layer 20 is covered by a cover sheet 22, which is removed before the sealing tape is used. The use of any of support layers 20 cited above in combination with an adhesive layer 15 as described in conjunction with FIG. 1 is also contemplated.

Fastening means other than an adhesive layer for attaching the sealing tape to the structural component may also be utilized. Specifically, mechanical means of any suitable type is also contemplated.

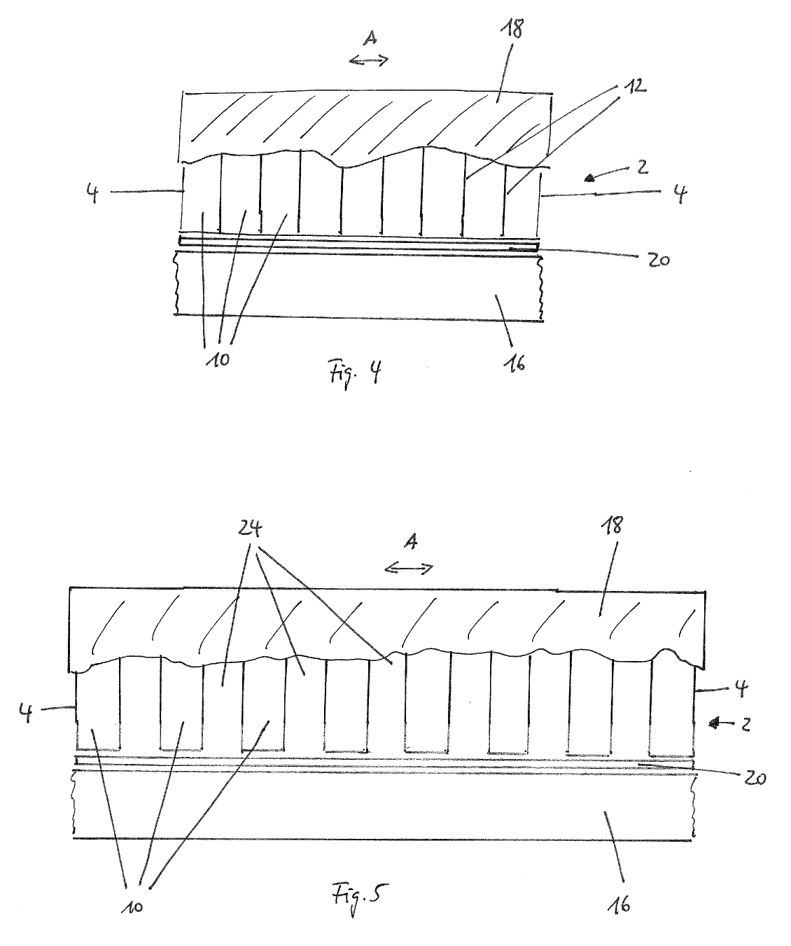

When the support layer 20 is stretchable, the sealing tape can seal joints of varying depth, in that the sealing tape may be pulled apart to the desired width, as can be seen in FIGS. 4 and 5.

In the normal state of the sealing tape, foam segments 10 rest closely against each other; see the exemplary embodiment in a shallow joint such as that illustrated in FIG. 4.

By pulling apart foam strip 2 in the transverse direction A of the sealing tape, cuts 12 are widened to form intermediate spaces 24 between the individual foam segments 10, as shown in the exemplary embodiment in a joint of considerable depth in FIG. 5. These intermediate spaces 24 also provide an insulating function as a result of the air contained within each such space.

The sealing tape can be produced basically both in the form of strips and in the form of sealing tape rolls. After the sealing tape has been unwound from the sealing tape roll, the time available to attach the sealing tape to structural component 16 and to insert component 16 into the opening in masonry 18 usually lasts until the expansion of foam segments 10 of the foam strip makes the sealing tape too large to fit into the opening. Such expansion is typically delayed to allow placement of structural component 16 in its intended location. Because impregnation agents make it possible today to delay the expansion of the foam by several hours, the time factor therefore does not represent a significant limitation. When the sealing tape is in the form of strips, it will be necessary to compress the strip before inserting it into the joint.

It will be appreciated that the sealing tape could also be attached to component 16 to be sealed even before it is transported. For this purpose, however, it would be necessary to provide a wrapper (not shown) around the sealing tape to prevent it from expanding. After installation in the desired opening in the building on site, it is then necessary simply to open the wrapper, whereupon foam segments 10 of foam strip 2 expand upward and ensure the sealing of the joint.

Reference throughout this specification to “one embodiment,” “an embodiment,” “a preferred embodiment,” “alternate embodiment” or similar language means that a particular feature, structure, or characteristic described in connection with the embodiment is included in at least one embodiment of the present invention. Thus, appearances of the phrases “in one embodiment,” “in an embodiment,” “in a preferred embodiment,” “in an alternate embodiment,” and similar language throughout this specification may, but do not necessarily, all refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

While the present invention has been described in connection with certain exemplary, alternate or specific embodiments, it is to be understood that the invention is not limited to the disclosed embodiments, but, on the contrary, is intended to cover various modifications, alternatives, modifications and equivalent arrangements as will be apparent to those skilled in the art. Any such changes, modifications, alternatives, modifications, equivalents and the like may be made without departing from the spirit and scope of the invention.

What is claimed is:

1. A sealing tape comprising:
a foam strip of flexible foam, which has two side surfaces, a top surface, and a bottom surface, the side surfaces extending along a longitudinal direction,
the foam strip further comprising a plurality of three-dimensional foam segments, which are separated from each other by cuts extending downward from the top surface into the foam strip, at least some of the plurality of foam segments being surrounded completely in the longitudinal direction and in a direction transverse to the longitudinal direction by other ones of the plurality of foam segments.

2. The sealing tape of claim 1 wherein, when the foam strip is in an expanded state, the foam segments extend over at least 50% of a height of the foam strip.

3. The sealing tape of claim 2 wherein, when the foam strip is in the expanded state, the foam segments extend over at least 60% of the height of the foam strip.

4. The sealing tape of claim 3 wherein, when the foam strip is in the expanded state, the foam segments extend over at least 70% of the height of the foam strip.

5. The sealing tape of claim 4 wherein, when the foam strip is in the expanded state, the foam segments extend over at least 90% of the height of the foam strip.

6. The sealing tape of claim 2 wherein, in an area of the bottom surface, the foam strip comprises a web, which connects the foam segments to each other.

7. The sealing tape of claim 1 wherein, when the foam strip is in an expanded state, the foam segments extend over 100% of a height of the foam strip.

8. The sealing tape of claim 1 wherein a plurality of the cuts extends substantially parallel to the side surfaces.

9. The sealing tape of claim 8 wherein a plurality of the cuts extends substantially perpendicular to the side surfaces.

10. The sealing tape of claim 1 further comprising a support layer, which is adhered to the bottom surface of the foam strip.

11. The sealing tape of claim 10 wherein the support layer is stretchable.

12. The sealing tape of claim 1 wherein a pressure-sensitive adhesive strip is arranged on the bottom surface of the foam strip.

13. The sealing tape of claim 10 wherein a pressure-sensitive adhesive strip is arranged on an underside of the support layer.

14. The sealing tape of claim 10 wherein the support layer comprises a double-side adhesive tape.

15. The sealing tape of claim 1 wound up into a roll.
